(19) United States
(12) Patent Application Publication
(10) Pub. No.: US 2015/0198626 A1
(43) Pub. Date: Jul. 16, 2015

(54) ACCELERATION SENSOR

(71) Applicant: SAMSUNG ELECTRO-MECHANICS CO., LTD., Gyeonggi-Do (KR)

(72) Inventors: Tae Yoon KIM, Gyeonggi-Do (KR); Chang Hyun LIM, Gyeonggi-Do (KR); Jong Woon KIM, Gyeonggi-Do (KR)

(73) Assignee: SAMSUNG ELECTRO-MECHANICS CO., LTD., Gyeonggi-Do (KR)

(21) Appl. No.: 14/465,390

(22) Filed: Aug. 21, 2014

(30) Foreign Application Priority Data
Jan. 16, 2014 (KR) 10-2014-0005676

(51) Int. Cl. G01P 15/12

(52) U.S. Cl. CPC G01P 15/123

(57) ABSTRACT

Embodiments of the invention provide an acceleration sensor, including a sensor part comprising a mass body part including a first mass body, a second mass body, and a connecting layer connecting the first mass body and the second mass body to each other, a flexible beam having the mass body part connected thereto to be displaceable, and a supporting part having the flexible beam connected thereto and supporting the mass body part to be floatable. The acceleration sensor further includes a cover coupled to the supporting part to cover the sensor part, being opposite to the first mass body to thereby form a cavity, and being opposite to the second mass body to thereby form a protrusion part.

### CROSS REFERENCE TO RELATED APPLICATION

This application claims the benefit of and priority under 35 U.S.C. §119 to Korean Patent Application No. KR 10-2014-0005676, entitled “ACCELERATION SENSOR,” filed on Jan. 16, 2014, which is hereby incorporated by reference in its entirety into this application.

### BACKGROUND

1. Field of the Invention

The invention relates to an acceleration sensor.

2. Description of the Related Art

In general, an inertia sensor, which has been variously used, for example, for a vehicle, an airplane, a mobile communication terminal, a toy, requires a three-axis acceleration, angular velocity sensor measuring acceleration, and angular velocity of an X axis, a Y axis, and a Z axis, and has been developed in high performance and miniaturization, in order to detect fine acceleration.

The acceleration sensor among the inertia sensors as mentioned above includes, for example, technical characteristics converting motions of a mass body and a flexible beam into an electrical signal and is classified into a piezo-resistive type detecting the motion of the mass body from a resistance change of a piezoresistive element disposed on the flexible beam, or a capacitive type detecting the motion of the mass body from a capacitance change between fixed electrodes, as non-limiting examples.

In addition, the piezo-resistive type uses an, element having a resistance value, which is changed by stress. For example, where tensile stress is distributed, the resistance value is increased, and where compressive stress is distributed, the resistance value is decreased.

In addition, since an acceleration sensor of a piezoresistive type, according to the conventional art, as described, for example, in U.S. Patent Publication No. 2006/0156818, an area of a beam is decreased to increase sensitivity, and therefore it may be vulnerable to impact, need to perform a complex process when forming a stopper to prevent over-displacement of the mass body, and decrease productivity.

### SUMMARY

Accordingly, embodiments of the invention to provide an acceleration sensor capable of being implemented as an acceleration sensor having stability and reliability because a mass body part is formed by a first mass body and a second mass body, and only the second mass body contacts a cover and a connecting layer connecting the first mass body and the second mass body to each other absorbs impact when the mass body part is excessively displaced, such that the first mass body does not contact anywhere, and capable of adjusting an impact absorbing amount by setting the number of second mass bodies.

Embodiments of the invention has been made in an effort to provide an acceleration sensor capable of being manufactured through a simple process by forming a damping unit only by a process of forming the mass body part and having improved productivity because a separate damping unit is not needed.

According to an embodiment of the invention, there is provided an acceleration sensor, including a sensor part comprising a mass body part including a first mass body, a second mass body, and a connecting layer connecting the first mass body and the second mass body to each other, a flexible beam having the mass body part connected thereto to be displaceable, and a supporting part having the flexible beam connected thereto and supporting the mass body part to be floatable. The acceleration sensor further includes a cover coupled to the supporting part to cover the sensor part, being opposite to the first mass body to thereby form a cavity, and being opposite to the second mass body to thereby form a protrusion part.

According to at least one embodiment, the cover includes a first cover covering one side of the sensor part and a second cover covering the other side of the sensor part, the first cover covers one side of the mass body part and the flexible beam, and the second cover covers the other side of the mass body part.

According to at least one embodiment, the first cover and the second cover form the protrusion and the cavity, a portion of the protrusion is coupled to the supporting part of the mass body part and the other portion thereof is formed to be opposite to the second mass body of the mass body part, and the cavity is formed to be opposite to the first mass body of the mass body part.

According to at least one embodiment, the first mass body is a main mass body for detecting an acceleration according to a displacement, and the second mass body is a damping mass body, which is connected to the outside of the first mass body by a connecting layer to be interlocked with the first mass body and contacts the cover when the mass body part is excessively displaced.

According to at least one embodiment, the second mass body is formed in a triangular prism shape, and when the second mass body is connected to the first mass body, the first mass body and the second mass body are generally formed in a rectangular parallelepiped shape.

According to at least one embodiment, the first mass body is provided with a plurality of groove parts extended from the outer part of the mass body part to the center pan thereof, and the flexible beam is each connected to the center part of the first mass body through the groove part of the first mass body.

According to at least one embodiment, the flexible beam is provided with a detecting unit for detecting a displacement of the mass body part.

According to at least one embodiment, the flexible beam and a connecting layer include a first layer, the first mass body and the second mass body include a second layer stacked on the first layer forming the connecting layer, and the supporting layer includes the first layer and the second layer.

According to at least one embodiment, the first layer and the second layer have an oxide layer, which is a connecting layer, formed therebetween.

According to at least one embodiment, the first layer is formed by a SOI wafer, which is a first substrate, and the second layer is formed by a bare wafer, which is a second substrate.

According to at least one embodiment, the first substrate and the second substrate are coupled to each other by a silicon direct bonding scheme.

According to another embodiment of the invention, there is provided an acceleration sensor, including a sensor part including a mass body part including a first mass body including a centric mass body and peripheral mass bodies disposed so as to be extended from the centric mass body to every direction, a plurality of second mass bodies, and a connecting layer connecting the peripheral mass bodies and the plurality of second mass bodies to each other; a flexible beam having the mass body part connected thereto to be displaceable. According to this embodiment, there is also provided a supporting part having the flexible beam connected thereto and supporting the mass body part to be floatable, and a cover coupled to the supporting part to cover the sensor part, being opposite to the first mass body to thereby form a cavity, and being opposite to the plurality of second mass bodies to thereby form a protrusion part.

According to at least one embodiment, three second mass bodies are provided to be each connected to end portions in three directions of the peripheral mass bodies.

According to at least one embodiment, the cover includes a first cover covering one side of the sensor part and a second cover covering the other side of the sensor part, the first cover covers one side of the mass body part and the flexible beam, and the second cover covers the other side of the mass body part.

According to at least one embodiment, the first cover and the second cover form the protrusion and the cavity, a portion of the protrusion is coupled to the supporting part of the mass body part and the other portion thereof is formed to be opposite to the plurality of second mass bodies, and the cavity is formed to be opposite to the first mass body of the mass body part.

According to at least one embodiment, the first mass body is a main mass body for detecting an acceleration according to a displacement, and the plurality of second mass bodies are damping mass bodies, which are each connected to the outside of the peripheral mass bodies of the first mass body by a connecting layer to be interlocked with the first mass body and contacts the cover when the mass body part is excessively displaced.

According to at least one embodiment, the plurality of second mass bodies are formed in a triangular prism shape, and when the plurality of second mass bodies are each connected to the peripheral mass bodies of the first mass body, the first mass body and the plurality of second mass bodies are generally formed in a rectangular parallelepiped shape.

According to at least one embodiment, the first mass body includes a centric mass body and a plurality of peripheral mass bodies formed by a plurality of groove parts extended from the outer part of the mass body part to the center part thereof, and the flexible beam may be each connected to the centric mass body through the groove part of the first mass body.

According to at least one embodiment, the flexible beam is provided with a detecting unit for detecting a displacement of the mass body part.

According to at least one embodiment, the flexible beam and a connecting include a first layer, the first mass body and the plurality of second mass bodies include a second layer stacked on the first layer forming the connecting layer, and the supporting layer includes the first layer and the second layer.

According to at least one embodiment, the first layer and the second layer have an oxide layer, which is a connecting layer, formed therebetween.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIGS. 1A to 1C are schematic conceptual diagrams for a basic principle of an acceleration sensor according to an embodiment of the invention, and more particularly, FIG. 1A is a configuration diagram, and FIGS. 1B and 1C are usage state views.

FIG. 2 is a schematic basic configuration diagram for implementing the acceleration sensor shown in FIG. 1 according to an embodiment of the invention.

FIGS. 3A to 3C schematically show an acceleration sensor according to an embodiment of the invention, and more particularly, FIG. 3A is a plan view of a sensor unit, FIG. 3B is a plan view of a cover unit, and FIG. 3C is a plan view showing a state in which die sensor unit and the cover unit are coupled to each other.

FIG. 4 is a schematic cross-sectional view taken along a line A-A′ of the acceleration sensor shown in FIG. 3A according to an embodiment of the invention.

FIGS. 5A and 5B are perspective views schematically showing a mass body part according to an embodiment of the invention.

FIGS. 6A and 6B are schematic usage state views of the acceleration sensor shown in FIG. 1 according to an embodiment of the invention.

FIGS. 7A to 7C are plan views schematically showing a sensor unit and a cover unit of an acceleration sensor according to another embodiment of the invention, and more particularly, FIG. 7A is a plan view of the sensor unit, FIG. 7B is a plan view of the cover unit, and FIG. 7C is a plan view showing a state in which the sensor unit and the cover unit are coupled to each other.

FIG. 8 is a schematic cross-sectional view taken along a line B-B′ of the acceleration sensor shown in FIG. 7A according to an embodiment of the invention.

### DETAILED DESCRIPTION

Advantages and features of the invention and methods of accomplishing the same will be apparent by referring to embodiments described below in detail in connection with the accompanying drawings. However, the invention is not limited to the embodiments disclosed below and may be implemented in various different forms. The embodiments are provided only for completing the disclosure of the invention and for fully representing the scope of the invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the invention. Like reference numerals refer to like elements throughout the specification.

A matter regarding to an operational effect including a technical configuration for an object of a coil unit for a thin film inductor and a manufacturing method thereof and a thin film inductor and a manufacturing method thereof in accordance with embodiments of the invention will be clearly appreciated through the following detailed description with reference to the accompanying drawings showing preferable embodiments of the present invention.

Hereinafter, various embodiments of the invention will be described in detail with reference to the accompanying drawings.

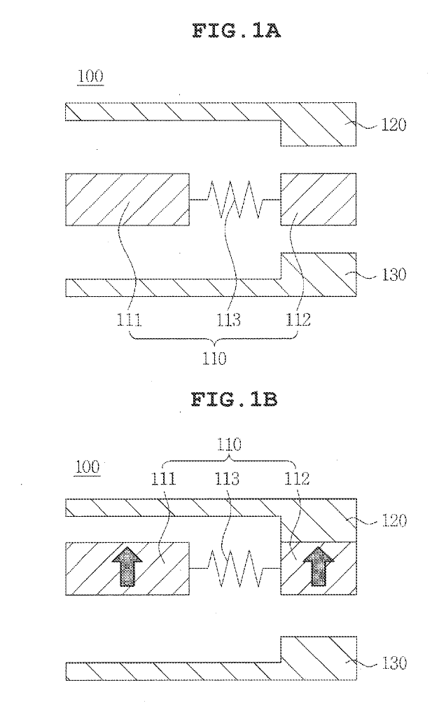

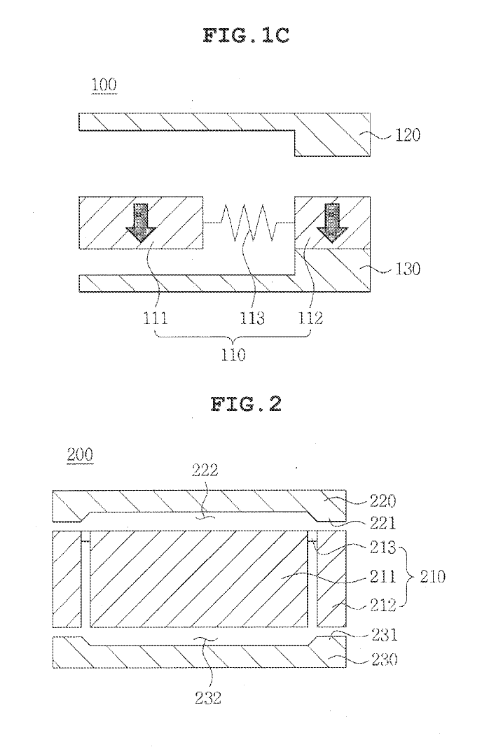

FIGS. 1A to 1C are schematic conceptual diagrams for a basic principle of an acceleration sensor according to an embodiment of the invention, and more particularly, FIG. 1A is a configuration diagram, FIGS. 1B and 1C are usage state views; and FIG. 2 is a schematic basic configuration diagram for implementing the acceleration sensor shown in FIG. 1 according to an embodiment of the invention.

As shown, the acceleration sensor 100 according to an embodiment of the invention includes a mass body part 110, a first cover 120, and a second cover 130.

According to at least one embodiment, the first cover 120 and the second cover 130 are positioned at both sides of the mass body part 110 with respect to one axial direction.

According to at least one embodiment, the mass body part 110 includes a first mass body 111, a second mass body 112, and a connection part 113. According to at least one embodiment, the connection part 113 connects the first mass body 111 and the second mass body 112 to each other and is implemented as an impact absorbing part.

More specifically, as shown in FIGS. 1B and 1C, when the mass body part 110 is excessively displaced to thereby be ascended or descended in one axial direction, only the second mass body 112 contacts the first cover 120 and the second cover 130. According to at least one embodiment, an impacting amount generated from the above-mentioned case is absorbed and buffered by the connection part 113.

Therefore, when the excessive displacement is generated, the second mass body 112 limits the displacement and the connection part 113 serves as the impact absorbing part, such that the first mass body 111 does not contact anywhere, thereby making it possible to stably and reliably implement the sensor.

FIG. 2 is a schematic basic configuration diagram for implementing the acceleration sensor shown in FIG. 1 according to an embodiment of the invention. As shown in FIG. 2, the acceleration sensor 200, according to at least one embodiment of the invention, includes a mass body part 210, a first cover 220, and a second cover 230, wherein the first cover 220 and the second cover 230 are positioned to cover one side and the other side of the mass body part 110 in one axial direction.

According to at least one embodiment, the mass body part 210 include a first mass body 211, a second mass body 212, and a connection part 213. According to at least one embodiment, the connection part 213 connects the first mass body 211 and the second mass body 212 to each other.

According to at least one embodiment, the first cover 220 and the second cover 230 are each provided with protrusion parts 221 and 2.31 corresponding to the second mass body 212 of the mass body part 210, and cavities 222 and 232 are formed by forming the protrusion parts 221 and 231.

By the configuration described above, when the mass body part 210 is excessively displaced, the second mass body 212 contacts the protrusion parts 221 and 231 formed on the first cover 220 and the second cover 230, and the first mass body 211 does not contact anywhere by the cavities 222 and 232 of the first cover 220 and the second cover 230.

Hereinafter, a specific shape and an organic coupling of each of components of an acceleration sensor according to an embodiment of the invention for implementing the above-described technical characteristics and technical configurations will be described in more detail.

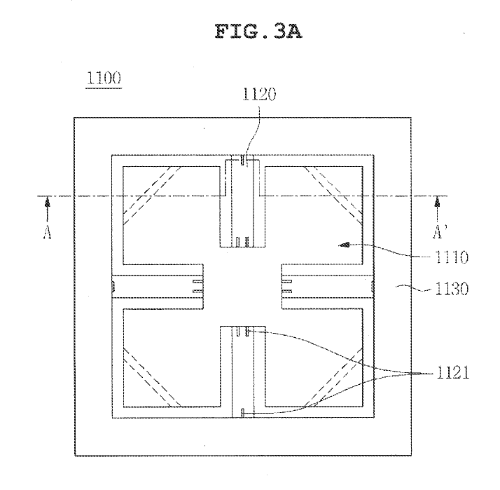

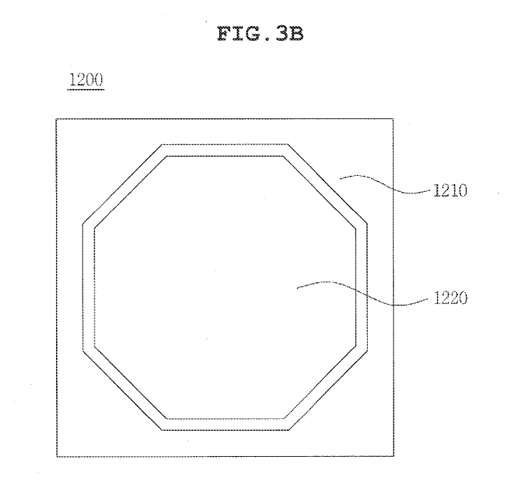

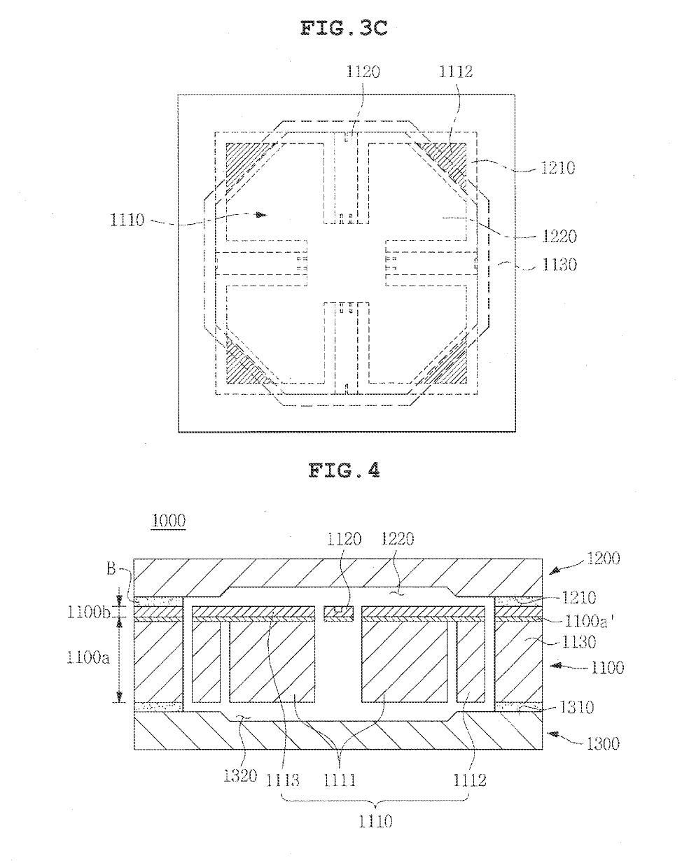

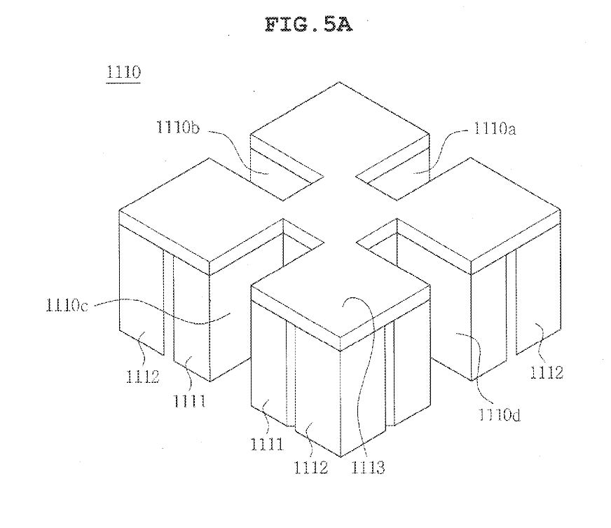

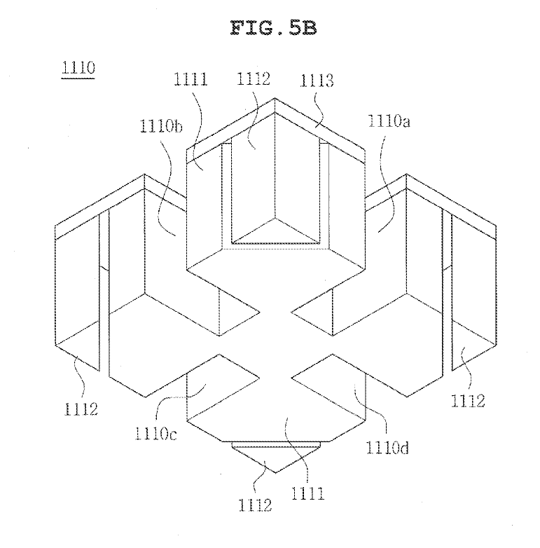

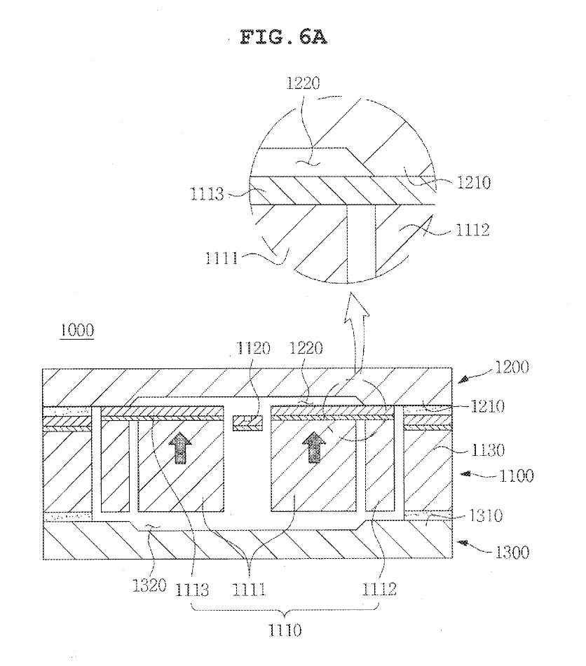

FIGS. 3A to 3C schematically show an acceleration sensor according to an embodiment of the invention, and more particularly, FIG. 3A is a plan view of a sensor unit, FIG. 3B is a plan view of a cover unit, and FIG. 3C is a plan view showing a state in which the sensor unit and the cover unit are coupled to each other; FIG. 4 is a schematic cross-sectional view taken along a line A-A′ of the acceleration sensor shown FIG. 3A according to an embodiment of the invention, and FIGS. 5A and 5B are perspective views schematically showing a mass body part according to an embodiment of the invention.

According to at least one embodiment, the acceleration sensor 1000 includes a sensor part 1100, and a first cover 1200 and a second cover 1300, which are a cover. In addition, the sensor part 1100 includes a mass body part including a first mass body, a second mass body, and a connection part connecting the first mass body and the second mass body to each other, a flexible beam having the mass body part connected thereto to be displaceable, and a supporting part having the flexible beam connected thereto and supporting the mass body part to be floatable.

According to at least one embodiment, the cover is coupled to the supporting part to cover the sensor part, be opposite to the first mass body to thereby form a cavity, and opposite to the second mass body to thereby form a protrusion part.

According to at least one embodiment, the first cover 1200 of the cover is coupled to the sensor part 1110 to cover one side of the sensor part 1100 and the second cover 1300 is coupled to the sensor part 1100 to cover the other side of the sensor part 1100.

More specifically, the sensor part 1100, according to at least one embodiment, includes a mass body part 1110, a flexible beam 1120, and a supporting part 1130. According to at least one embodiment, the mass body part 1110 is displaceably coupled to the flexible beam 1120 and is displaced by, for example, inertial force, external force, Coriolis force, or driving force.

According to at least one embodiment, as shown in FIG. 4, the mass body part 1110 includes a first mass body part 1111, a second mass body 1112, and a connecting layer 1113, which is a connection part connecting the first mass body 1111 and the second mass body 1112 to each other.

According to at least one embodiment, the first mass body 1111 is a main mass body for detecting acceleration according to the displacement and the second mass body 1112 is connected to the connecting layer 1113 to be interlocked with the first mass body 1111.

According to at least one embodiment, the second mass body 1112 is a damping mass body, which directly or indirectly contacts the first cover 1200 or the second cover 1300, when the mass body part 1110 is excessively displaced to thereby absorb impact.

According to at least one embodiment, the second mass body serves as the damping mass body, when the excessive displacement is generated and may be implemented as the mass body for detecting the acceleration other than that described above.

According to at least one embodiment, the second mass body 1112 is connected to the outside of the first mass body 1111 by the connecting layer 1113.

According to at least one embodiment, the second mass body 1112 is formed in a triangular prism shape. In addition, when the second mass body 1112 is connected to the first mass body 1111, the first mass body 1111 and the second mass body 1112 are generally formed in a rectangular parallelepiped shape.

According to at least one embodiment, the mass body part 1110 has four groove parts 1110a, 1110b, 1110c, and 1110d formed at an equidistant interval so that the flexible beam 1120 is connected thereto from every direction, and is formed in a rectangular parallelepiped shape.

Thus, in order for a center part of the mass body part 1110 to be displaceably fixed by the flexible beams 1120, the four groove parts 1110a, 1110b, 1110c, and 1110d are formed to be extended from the outer part of the mass body 1100 to the center part thereof, and the four flexible beams 1120 are each coupled to the center part of the mass body 1100 from every direction.

According to at least one embodiment, although a case in which the mass body part 1110 has a substantially square pillar shape is shown as an example, the mass body part 1110 is not limited to having the above-mentioned shape, but may have all shapes known in the art.

Next, the flexible beam 1120 is formed in a plate shape and is formed by a flexible substrate, such as a membrane and a beam, as non-limiting examples, having elasticity so that the mass body part 1110 is displaced. In addition, one end of the flexible beam 1120 is connected to the center part of the mass body part 1110 through the groove parts 1110a, 1110b, 1110c, and 1110d of the mass body part 1110, and the other end thereof is connected to the supporting part 1130.

According to at least one embodiment, one surface of the flexible beam 1120 is provided with a detecting unit 1121 for detecting a displacement of the mass body, wherein the detecting unit 1121 is variously formed by, for example, a piezo-electric body, and a piezo-resistive body.

Next, the supporting part 1130 has the flexible beams 1120 having the mass body part 1110 coupled to thereto, supports the mass body part 1110 to be floatable, and is formed in a hollow type so that the mass body part 1110 is displaceable, thereby securing a space in which the mass body 1100 may be displaced.

According to at least one embodiment, the sensor part 1100 of the acceleration sensor 1000 according to an embodiment of the invention includes a first layer 1100a and a second layer 1100b. Thus, patterns are differently formed on each of the first layer 1100a and the second layer 1100b are etched to form the respective components, such that the degree of freedom of a design is increased and the mass body part is simply formed by the first mass body and the second mass body.

According to at least one embodiment, each component of the sensor part 1100 includes only the first layer 1100a or include the first layer 1100a and the second layer 1100b.

More specifically, the flexible beam 1120 includes the first layer 1100a, the mass body part 1120 includes the first layer 1100a and the second layer 1100b, and the supporting part 1130 includes the first layer 1100a and the second layer 1100b.

According to at least one embodiment, the first mass body 1111 and the second mass body 1112 of the mass body part 1120 include the second layer 1100b, and the connecting layer 1113 includes the first layer 1100a.

According to at least one embodiment, the first layer 1100a is formed by a SOI wafer, which is a first substrate, and the second layer 1100b is formed by a bare wafer, which is a second substrate. In addition, the first substrate and the second substrate are coupled to each other by a silicon direct bonding scheme.

According to at least one embodiment, an oxide layer 1100a′, which is a connecting layer, is formed between the first layer 1100a and the second layer 1100b. In addition, the mass body part 1110, the flexible beam 1120, and the supporting part 1130 of the acceleration sensor 1000 are formed by the oxide layer 1100a′, which is a masking pattern formed on the first layer 1100a and the second layer 1100b.

According to at least one embodiment, the first cover 1200 covers one side of the mass body part 1110, which is one side of the sensor part 1100 and the flexible beam 1120, and is coupled to one surface of the supporting part 1130. That is, the first cover 1200, which is an upper cover, is coupled to the supporting part 1130 and covers the detecting unit 1121 formed on the flexible beam 1120.

According to at least one embodiment, the first cover 1200 forms the protrusion part 1210 and the cavity 1220. In addition, a portion of the protrusion part 1210 is coupled to the supporting part 1130, the other portion thereof is formed to he opposite to the second mass body 1112 of the mass body part 1110, and the cavity 1220 is formed to be opposite to the first mass body 1111 of the mass body part 1110. Thus, as shown in FIGS. 3C and 4, the portion of the protrusion part 1210 is positioned at an upper side of the second mass body 1112 and the cavity 1220 is positioned at an upper side of the first mass body 1111.

Therefore, the protrusion part 1210 of the first cover 1200 contacts the second mass body 1112, when the mass body part 1110 is excessively displaced to thereby serve as a stopper part.

According to at least one embodiment, the second cover 1300 covers the other side of the mass body part 1110, which is the other side of the sensor part 1100, and is coupled to the other surface of the supporting part 1130. That is, the second cover 1300, which is a lower cover, is coupled to the supporting part 1130 and covers a lower portion of the mass body part 1110.

According to at least one embodiment, the second cover 1300 forms the protrusion part 1310 and the cavity 1320. In addition, a portion of the protrusion part 1310 is coupled to the supporting part 1130, the other portion thereof is formed to be opposite to the second mass body 1112 of the mass body part 1110, and the cavity 1220 is formed to be opposite to the first mass body 1111 of the mass body part 1110. Thus, as shown in FIG. 4, the portion of the protrusion part 1310 is positioned at a lower side of the second mass body 1112 and the cavity 1320 is positioned at a lower side of the first mass body 1111.

Therefore, the protrusion part 1310 of the first cover 1200 contacts the second mass body 1112, when the mass body part 1110 is excessively displaced to thereby serve as a stopper part.

According to at least one embodiment, as shown in FIG. 4, in the acceleration sensor 1000 according to an embodiment of the invention, the first cover 1200 and the second cover 1300 are coupled to the sensor part 1100 by a bonding agent B and an interval between the mass body part 1110 and the first cover 1200 or the second cover 1300 is adjusted by a thickness of the bonding agent B.

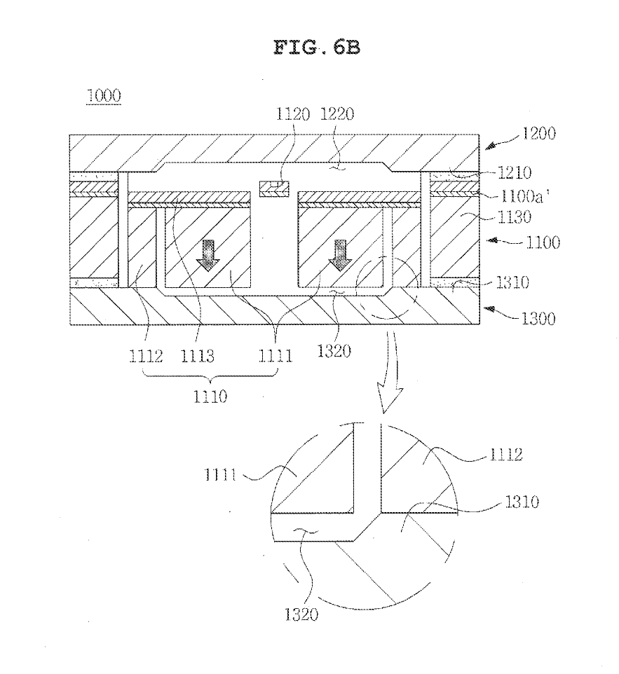

FIGS. 6A and 6B are schematic usage state views of the acceleration sensor shown in FIG. 1 according to an embodiment of the invention. First, as shown in FIG. 6A, when the acceleration sensor 1000 is excessively displaced toward an upward direction by external impact, for example, the first mass body 1111 and the second mass body 1112 are upwardly moved and the connecting layer 1113 formed on the second mass body 1112 contacts the protrusion part 1210 of the first cover 1200, thereby limiting further displacement.

According to at least one embodiment, the connecting layer 1113 damps an impact amount of the mass body part 1110 and the first cover 1200. In addition, the connecting layer 1113 formed on the first mass body 1111 is positioned in the cavity 1220 of the first cover 1200 and does not contact the first cover, such that direct impact on the first mass body 1111 is not generated.

Next, as shown in FIG, 6B, when the acceleration sensor 1000 is excessively displaced toward a downward direction by external impact, for example, the first mass body 1111 and the second mass body 1112 are downwardly moved and the lower portion of the second mass body 1112 contacts the protrusion part 1310 of the second cover 1300, thereby limiting further displacement.

According to at least one embodiment, the connecting layer 1113 clamps an impact amount of the second mass body 1112 and the second cover 1300. In addition, the first mass body 1111 is positioned in the cavity 1320 of the second cover 1300 and does not contact the second cover 1300.

By implementing the acceleration sensor 1000 according to an embodiment of the invention as described above, because the mass body part 1110 is formed by the first mass body 1111 and the second mass body 1112, only the second mass body 1112 contacts the first cover 1200 or the second cover 1300 when the mass body part 1110 is excessively displaced, and the connection part 1113 absorbs the impact, the first mass body 1111 does not contact anywhere, such that the acceleration sensor 1000 is implemented as a sensor having stability and reliability, and the acceleration sensor capable of being manufactured through a simple process by forming a damping unit only by a process of forming the mass body part and having improved productivity because a separate damping unit is not needed is obtained.

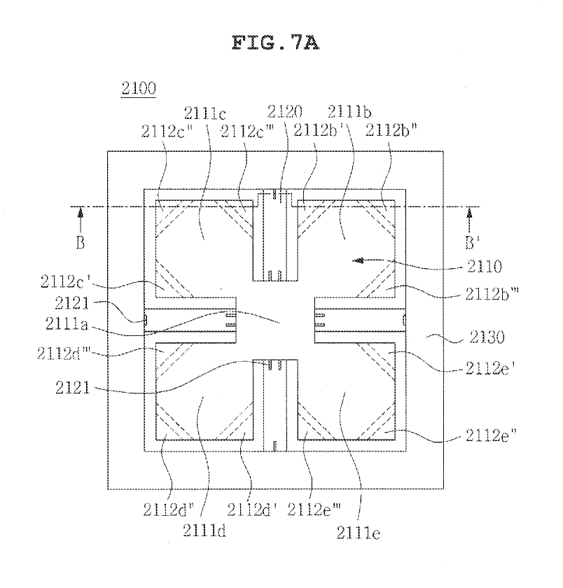

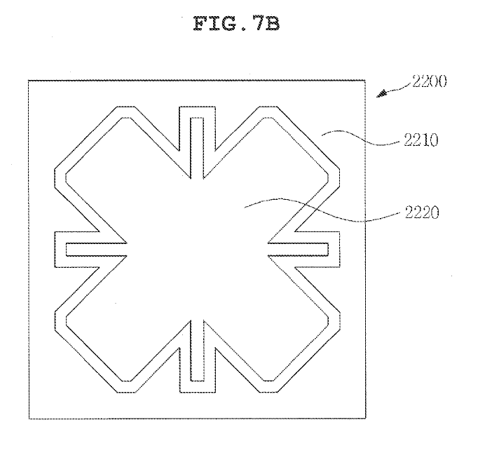

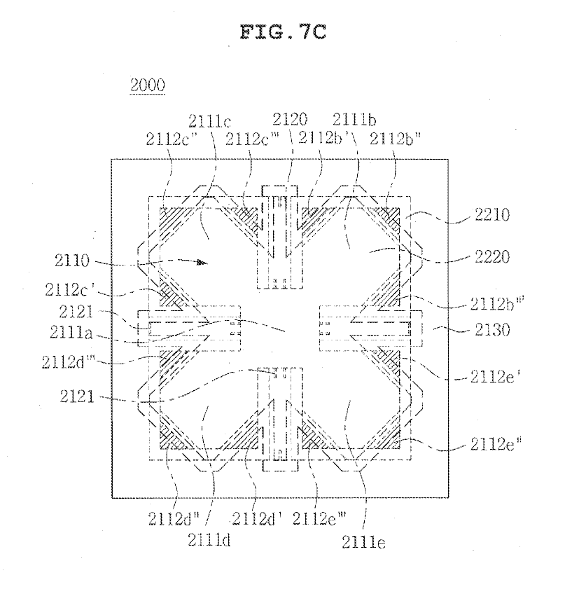

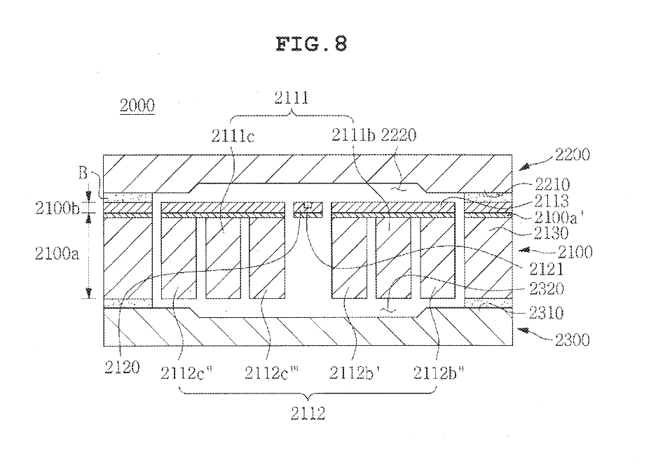

FIGS. 7A to 7C are plan views schematically showing a sensor unit and a cover unit of an acceleration sensor according to another embodiment of the invention, and more particularly, FIG. 7A is a plan view of the sensor unit, FIG. 7B is a plan view of the cover unit, and FIG. 7C is a plan view showing a state in which the sensor unit and the cover unit are coupled to each other; and FIG. 8 is a schematic cross-sectional view taken along a line B-B′ of the acceleration sensor shown in FIG. 7A according to an embodiment of the invention.

As shown, the acceleration sensor 2000 has a difference only in shapes of the mass body part and a first cover and a second cover, which are opposite to the mass body part as compared to the acceleration sensor 1000 according to an embodiment of the invention.

More specifically, the acceleration sensor 2000, according to at least one embodiment of the invention, includes a sensor part 2100, and a first cover 2200 and a second cover 2300, which are a cover. According to at least one embodiment, the sensor part 2100 includes a mass body part 2110, a flexible beam 2120, and a supporting part 2130, wherein the mass body part 2110 includes a first mass body including a centric mass body 2111a and peripheral mass bodies 2111b. 2111c, 2111d, and 2111e disposed to be extended from the centric mass body 2111a to every direction, a plurality of second mass bodies 2112, and a connecting layer 2113, which is a connection part connecting the peripheral mass bodies 2111b, 2111c, 2111d, and 2111e and the plurality of second mass bodies 2112 to each other.

According to at least one embodiment, the flexible beam has the mass body part connected thereto to be displaceable, and the supporting part has the flexible bean connected thereto and supports the mass body part to be floatable.

According to at least one embodiment, the first cover and the second cover, which are the cover is coupled to the supporting part to cover the sensor part, is opposite to the first mass body to thereby form a cavity, and is opposite to the plurality of second mass bodies to thereby form a protrusion part.

According to at least one embodiment, the first cover 2200 of the cover is coupled to the sensor part 2100 to cover one side of the sensor part 2100 and the second cover 2300 is coupled to the sensor part 2100 to cover the other side of the sensor part 2100.

As described above, the first mass body 2111 includes the centric mass body 2111a, and the peripheral mass bodies 2111b, 2111c, 2111d, and 2111e disposed as to be extended from the centric mass body 2111a to every direction. In addition, the plurality of second mass bodies 2112 are connected to the peripheral mass bodies, respectively, and are damping mass bodies directly or indirectly contacting the first cover 2200 or the second cover 2300, when the mass body part 2110 is excessively displaced to thereby absorb impact. To this end, the plurality of second mass bodies 2112 are each connected to the outsides of the peripheral mass bodies 2111b, 2111c, 2111d, and 2111e of the first mass body 2111 by the connecting layer 2113.

According to at least one embodiment, the plurality of second mass bodies 2112 are formed at all of end portions in three directions of the peripheral mass bodies 2111b, 2111c, 2111d, and 2111e, unlike the plurality of second mass bodies of the acceleration sensor according to the embodiment of the invention shown in FIG. 3A.

Thus, the plurality of second mass bodies 2112b′, 2112b″, and 2112b′ are each formed at the end portions in the three directions of the peripheral mass body 2112b, the plurality of second mass bodies 2112e′, 2112e″, and 2112e′″ are each formed at the end portions in the three directions of the peripheral mass body 2112c, the plurality of second mass bodies 2112d′, 2112d″, and 2112d′″ are each formed at the end portions in the three directions of the peripheral mass body 2112d, and the plurality of second mass bodies 2112e′, 2112e″, and 2112e′″ are each formed at the end portions in the three directions of the peripheral mass body 2112e.

According to at least one embodiment, the plurality of second mass bodies 2112 are formed in a triangular prism shape. In addition, when the plurality of second mass bodies 2112 are connected to the first mass body 2111, the first mass body 2111 and the plurality of second mass bodies 2112 are generally formed in a rectangular parallelepiped shape.

By the configuration described above, the number of plurality of second mass bodies formed to be each connected to the peripheral mass bodies 2111b, 2111c, 2111d, and 2111e adjust a damping amount.

In addition, when the peripheral mass body is formed in a circular shape, the plurality of second mass bodies are formed in various shapes which are connected to the end portions of the peripheral mass bodies.

Next, the first cover 2200 covers one side of the mass body part 2110, which is one side of the sensor part 2100 and the flexible beam 2120, and is coupled to one surface of the supporting part 2130. Thus, the first cover 2200, which is an upper cover, is coupled to the supporting part 2130 and covers the detecting unit 2121 formed on the flexible beam 2120.

According to at least one embodiment, the first cover 2200 forms the protrusion part 2210 and the cavity 2220.

In addition, a portion of the protrusion part 2210 is coupled to the supporting part 2130 of the sensor part 2100, the other portion thereof is formed to be opposite to the plurality of second mass bodies 2112 of the mass body part 2110, and the cavity 2220 is formed to be opposite to the first mass body 2111 of the mass body part 2110.

Thus, as shown in FIGS. 7C and 8, the portion of the protrusion part 2210 is positioned at an upper side of the plurality of second mass bodies 2112 and the cavity 2220 is positioned at an upper side of the first mass body 2111.

Therefore, the protrusion part 2210 of the first cover 2200 contacts the plurality of second mass bodies 2112 and the connecting layer 2113 formed on the plurality of second mass bodies, when the mass body part 2110 is excessively displaced to thereby serve as a stopper part. In addition, the connecting layer 2130 absorbs an impact amount with the first cover 2200.

Next, the second cover 2300 covers the other side of the mass body part 2110, which is the other side of the sensor part 2100, and is coupled to the other surface of the supporting part 2130. Thus, the second cover 2300, which is a lower cover, is coupled to the supporting part 2130 and covers a lower portion of the mass body part 2110.

According to at least one embodiment, the second cover 2300 forms the protrusion part 2310 and the cavity 2320. In addition, a portion of the protrusion part 2310 is coupled to the supporting part 2130, the other portion thereof is formed to be opposite to the plurality of second mass bodies 2112 of the mass body part 2110, and the cavity 2220 is formed to be opposite to the first mass body 2111 of the mass body part 2110. Thus, as shown in FIG. 8, the portion of the protrusion part 2310 is positioned at a lower side of the plurality of second mass bodies 2112 and the cavity 2320 is positioned at a lower side of the first mass body 2111.

According to at least one embodiment, as shown in FIG. 8, in the acceleration sensor 2000 according to another embodiment of the invention, the first cover 2200 and the second cover 2300 are coupled to the sensor part 2100 by a bonding agent B and an interval between the mass body part 2110 and the first cover 2200 or the second cover 2300 are adjusted by a thickness of the bonding agent B.

Therefore, the protrusion part 2210 of the first cover 2200 contacts the plurality of second mass bodies 2112, when the mass body part 2110 is excessively displaced to thereby serve as a stopper part.

Thus, when the acceleration sensor 2000 is excessively displaced to an upward or downward direction by external impact, for example, the mass body part 2110 is upwardly or downwardly moved.

In this case, when the mass body part 2110 is upwardly displaced, the connecting layer 2113 formed on the plurality of second mass bodies 2112b′, 2112b″, 2112b′″, 2112c′, 2112c″, 2112c′″, 2112d′, 2112d″, 2112d′″, 2112e′, 2112e″, and 2112e′″ contact the first cover 2200 to thereby limit the displacement of the mass body part 2110, and the connecting layer 2113 damps the impact amount of the plurality of second mass bodies 2112b′, 2112b″, 2112b′″, 2112c′, 2112c″, 2112c′″, 2112d′, 2112d″, 2112d′″, 2112e′, 2112e″, and 2112e′″ and the first cover 2200.

According to at least one embodiment, when the mass body part 2110 is downwardly displaced, the plurality of second mass bodies 2112b′, 2112b″, 2112b′″, 2112c′, 2112c″, 2112c′″, 2112d′, 2112d″, 2112d′″, 2112e′, 2112e″, and 2112e′″ each contact the protrusion part 2310 of the second cover 2300, thereby limiting the displacement of the mass body part 2110.

According to at least one embodiment, the connecting layer 2113 damps the impact amount of the plurality of second mass bodies 2112b′, 2112b″, 2112b′″, 2112c′, 2112c″, 2112c′″, 2112d′, 2112d″, 2112d′″, 2112e′, 2112e″, and 2112e′″ and the second cover 2300. In addition, the first mass body 2111 is positioned in the cavity 2320 of the second cover 2300 and does not contact the second cover 2300.

According to at least one embodiment, the sensor part 2100 of the acceleration sensor 2000 according to another embodiment of the invention includes a first layer 2100a and a. second layer 2100b. Thus, patterns are differently formed on each of the first layer 2100a and the second layer 2100b and are etched to form the respective components, such that the degree of freedom of a design is increased and the mass body part is simply formed by the first mass body and the plurality of second mass bodies.

To this end, each component of the sensor part 2100 includes only the first layer 2100a or include the first layer 2100a and the second layer 2100b.

More specifically, the flexible beam 2120 includes the first layer 2100a, the mass body part 2120 includes the first layer 2100a and the second layer 2100b, and the supporting part 2130 includes the first layer 2100a and the second layer 2100b.

According to at least one embodiment, the first mass body 2111 and the plurality of second mass bodies 2112 of the mass body part 2120 include the secon.d layer 2100b, and the connecting layer 2113 includes the first layer 2100a.

According to at least one embodiment, the first layer 2100a is formed by a SOI wafer, which is a first substrate, and the second layer 2100b is formed by a hare wafer, which is a second substrate. in addition, the first substrate and the second substrate are coupled to each other by a silicon, direct bonding scheme.

According to at least one embodiment, an oxide layer 2100a′, which is a connecting layer, is formed between the first layer 2100a and the second layer 2100b. In addition, the mass body part 2110, the flexible beam 2120, and the supporting part 2130 of the acceleration sensor 2000 are formed by the oxide layer 2100a′, which is a masking pattern formed on the first layer 2100a and the second layer 2100b.

By the configuration described above, in the acceleration sensor 2000 according to various embodiments of the invention, when the mass body part 2110 is excessively displaced, as only the plurality of second mass bodies 2112 contact the first cover 2200 or the second cover 2300 and the connection part 2113 absorbs the impact, the first mass body 2111 does not contact anywhere, such that the acceleration sensor which is implemented as a sensor having stability raid reliability is obtained, and as the plurality of second mass bodies are formed to be connected to one first mass body, such that the impact absorbing amount are adjusted.

According to various embodiments of the invention, it is possible to obtain the acceleration sensor, which is capable of being implemented as an acceleration sensor having stability and reliability because the mass body part is formed by the first mass body and the second mass body, and only the second mass body contacts the cover, and the connection part connecting the first mass body and the second mass body to each other absorbs impact when the mass body part is excessively displaced, such that the first mass body does not contact anywhere, capable of adjusting the impact absorbing amount by setting the number of second mass bodies, capable of being manufactured through the simple process by forming a damping unit only by the process of forming the mass body part, and having improved productivity because the separate damping unit is not needed.

Terms used herein are provided to explain embodiments, not limiting the invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the invention may suitably comprise, consist or consist essentially of the elements disclosed and may be practiced in the absence of an element not disclosed. For example, it can he recognized by those skilled in the art that certain steps can be combined into a single step.

The terms and words used in the specification and claims should not be interpreted as being limited to typical meanings or dictionary definitions, but should be interpreted as having meanings and concepts relevant to the technical scope of the invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not xclude additional elements or steps.

As used herein, the terms “left,” “right,” “front,” “back,” “top,” “bottom,” “over,” “under” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein, The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the invention has been described in detail, it should be understood that various changes, substitutions, and alterations can be made hereupon without departing from the principle and scope of the invention. Accordingly, the scope of the invention should be determined by the following claims and their appropriate legal equivalents.

What is claimed is:

1. An acceleration sensor, comprising:
a sensor part comprising a mass body part including a first mass body, a second mass body, and a connecting layer connecting the first mass body and the second mass body to each other, a flexible beam having the mass body part connected thereto to be displaceable, and a supporting part having the flexible beam connected thereto and supporting the mass body part to be floatable; and
a cover coupled to the supporting part to cover the sensor part, being opposite to the first mass body to thereby form a cavity, and being opposite to the second mass body to thereby form a protrusion part.

2. The acceleration sensor as set forth in claim 1, wherein the cover comprises a first cover covering one side of the sensor part and a second. cover covering the other side of the sensor part,
wherein the first cover covers one side of the mass body part and the flexible beam, and
wherein the second cover covers the other side of the mass body part.

3. The acceleration sensor as set forth in claim 1, wherein the first cover and the second cover form the protrusion and the cavity,
wherein a portion of the protrusion is coupled to the supporting part of the mass body part and the other portion thereof is formed to be opposite to the second mass body of the mass body part, and
wherein the cavity is formed to be opposite to the first mass body of the mass body part.

4. The acceleration sensor as set forth in claim 1, wherein the first mass body is a main mass body for detecting an acceleration according to a displacement, and
wherein the second mass body is a damping mass body, which is connected to the outside of the first mass body by a connecting layer to be interlocked with the first mass body and contacts the cover when the mass body part is displaced.

5. The acceleration sensor as set forth in claim 4, wherein the second mass body is formed in a triangular prism shape, and when the second mass body is connected to the first mass body, the first mass body and the second mass body are generally formed in a rectangular parallelepiped shape.

6. The acceleration sensor as set forth in claim 1, wherein the first mass body is provided with a plurality of groove parts extended from the outer part of the mass body part to the center part thereof, and the flexible beam is each connected to the center part of the first mass body through the groove part of the first mass body.

7. The acceleration sensor as forth. in claim 6, wherein the flexible beam is provided with a detecting unit for detecting a displacement of the mass body part.

8. The acceleration sensor as set forth in claim 1, wherein the flexible beam and a connecting layer comprise a first layer,
wherein the first mass body and the second mass body comprise a second layer stacked on the first layer forming the connecting layer, and
the supporting layer comprises the first layer and the second layer.

9. The acceleration sensor as set forth in claim 8, wherein the first layer and the second layer comprise an oxide layer, which is a connecting layer, formed therebetween.

10. The acceleration sensor as set forth in claim 8, wherein the first layer is formed by a SOI wafer, which is a first substrate and the second layer is formed by a bare wafer, which is a second substrate.

11. The acceleration sensor as set forth in claim 10, wherein the first substrate and the second substrate are coupled to each other by a silicon direct bonding scheme.

12. An acceleration sensor, comprising:
a sensor part comprising a mass body part including a first mass body including a centric mass body and peripheral mass bodies disposed so as to be extended from the centric mass body to every direction, a plurality of second mass bodies, and a connecting layer connecting the peripheral mass bodies and the plurality of second mass bodies to each other; a flexible beam comprising the mass body part connected thereto to be displaceable; and a supporting part comprising the flexible beam connected thereto and supporting the mass body part to be floatable; and
a cover coupled to the supporting part to cover the sensor part, being opposite to the first mass body to thereby form a cavity, and being opposite to the plurality of second mass bodies to thereby form a protrusion part.

13. The acceleration sensor as set forth in claim 12, wherein three second mass bodies are provided to be each connected to end portions in three directions of the peripheral mass bodies.

14. The acceleration sensor as set forth in claim 12, wherein the cover comprises a first cover covering one side of the sensor part and a second cover covering the other side of the sensor part,
the first cover covers one side of the mass body part and the flexible beam, and
the second cover covers the other side of the mass body part.

15. The acceleration sensor as set forth in claim 12, wherein the first cover and the second cover form the protrusion and the cavity,
a portion of the protrusion is coupled to the supporting part of the mass body part and the other portion thereof is formed to he opposite to the plurality of second mass bodies, and
the cavity is formed to be opposite to the first mass body of the mass body part.

16. The acceleration sensor as set forth in claim 12, wherein the first mass body is a main mass body for detecting an acceleration according to a displacement, and
wherein the plurality of second mass bodies are damping mass bodies, which are each connected to the outside of the peripheral mass bodies of the first mass body by a connecting layer to be interlocked with the first mass body and contacts the cover, when the mass body part is excessively displaced.

17. The acceleration sensor as set forth in claim 16, wherein the plurality of second mass bodies are formed in a triangular prism shape, and when the plurality of second mass bodies are each connected to the peripheral mass bodies of the first mass body, the first mass body and the plurality of second mass bodies are generally formed in a rectangular parallelepiped shape.

18. The acceleration sensor as set forth in claim 12, wherein the first mass body includes a centric mass body and a plurality of peripheral mass bodies formed by a plurality of groove parts extended from the outer part of the mass body part to the center part thereof, and the flexible beam is each connected to the centric mass body through the groove part of the first mass body.

19. The acceleration sensor as set forth in claim 18, wherein the flexible beam is provided with a detecting unit for detecting a displacement of the mass body part.

20. The acceleration sensor as set forth in claim 12, wherein the flexible beam and a connecting layer comprise a first layer,
wherein the first mass body and the plurality of second mass bodies comprise a second layer stacked on the first layer forming the connecting layer, and
the supporting layer comprises the first layer and the second layer.

21. The acceleration sensor as set forth in claim 20, wherein the first layer and the second layer comprise an oxide layer, which is a connecting layer, formed therebetween.
